(19) United States
(12) Patent Application Publication
(10) Pub. No.: US 2012/0263991 A1
(43) Pub. Date: Oct. 18, 2012

(54) BATTERY PACK

(76) Inventors: Hiroshi Temmyo, Osaka (JP); Takuya Nakashima, Osaka (JP); Takashi Nakagawa, Osaka (JP)

(21) Appl. No.: 13/515,193

(22) PCT Filed: Sep. 21, 2011
(86) PCT No.: PCT/JP2011/005308

§ 371 Date: Jun. 11, 2012

(30) Foreign Application Priority Data
Nov. 29, 2010 (JP) 2010-264685

(51) Int. Cl. H01M 2/02; H01M 2/14; H01M 10/50

(52) U.S. Cl. 429/120

(57) ABSTRACT

Each battery module 100 includes a holder 20 accommodating cells 10 and made of a thermal conductive material, and a rectangular solid case 30 accommodating the holder 20. The holder 20 includes containers 21, in each of which one of the cells 10 is accommodated. The case 30 has a first side surface 30a and a second side surface 30b, which are parallel to side surfaces of the containers 21 of the holder 20, and face each other. The battery pack 200 is formed by stacking the battery modules 100 in a direction that the first side surface 30a and the second side surface 30b overlap each other. Spacers 50a and 50b, each of which has a predetermined width, are provided between adjacent two of the battery modules 100, at both ends of the first and second side surfaces 30a and 30b of the case 30 in a width direction, along a direction perpendicular to the width direction. The spacers 50a and 50b form a gap 60, through which a cooling medium flows, between the first and second side surfaces 30a and 30b.

### TECHNICAL FIELD

The present invention relates to battery packs formed by stacking a plurality of battery modules.

### BACKGROUND ART

Battery packs including a plurality of batteries accommodated in a case to output a predetermined voltage and capacitance are widely used as power sources of various devices, vehicles, etc. In particular, a technique of forming modules of assembled cells by connecting general-purpose batteries in parallel and/or in series to output a predetermined voltage and capacitance, and combining the battery modules together for various applications is beginning to be employed. This technique of forming a module reduces the size and weight of the battery modules themselves by increasing the performance of the batteries accommodated in the battery modules, and thus has various advantages such as an improvement in workability in assembling a battery pack, and in the flexibility in mounting the battery modules in limited space of a vehicle etc.

Batteries accommodated in a case of a battery module are heated in charge and discharge. Without being released outside the case, the heat is accumulated within the case and badly affects the batteries. In particular, in a battery pack formed by stacking a plurality of battery modules, heat release of the battery modules located at the inner side is reduced to excessively raise the temperature of the battery modules.

A technique is known, which increases the cooling effect of stacked battery modules by forming a plurality of projections in holding spacers for holding battery modules to contact the battery modules and by providing a gap, through which a cooling medium flows, between adjacent two of the battery modules. (See, or example, Patent Document 1.)

### CITATION LIST

### Patent Document

PATENT DOCUMENT 1: Japanese Patent Publication No. 2010-146777

### SUMMARY OF THE INVENTION

### Technical Problem

While the size and weight of the battery modules themselves can be reduced by improving the performance of the batteries accommodated in the battery modules, the energy density per unit volume increases, thereby increasing the amount of generated heat of the battery modules themselves.

In order to provide a sufficient cooling effect of battery modules in a battery pack formed by stacking the battery modules, a large gap needs to be provided between the battery modules. However, since a gap obtained as a cooling path is unnecessary space in the battery pack, the energy density per unit volume of the battery pack itself is rather reduced with an increase in the size of the gap. An increase in the volume of the battery pack goes against a demand for accommodating the battery pack in limited space.

The present invention was made in view of the problem, and it is a primary objective of the present invention to provide a battery pack exhibiting a great cooling effect of battery modules and requiring less space as a battery pack formed by stacking a plurality of battery modules.

### Solution to the Problem

In order to achieve the objective, the present invention employs in a battery pack formed by stacking a plurality of battery modules, the structure accommodating a plurality of batteries (batteries used in each battery module are hereinafter referred to as “cells”), which are arranged in a case of each of the battery modules, in a holder made of a thermal conductive material; and providing spacers between adjacent two of the battery modules at the both ends of the side surfaces of the case to form a gap, through which a cooling medium flows, between the adjacent two of the battery modules.

With this structure, the cells are accommodated in the holder made of the thermal conductive material, thereby immediately releasing the heat generated in the cells into the case of the battery module; and the spacers forming the gap serving as a flow path of the cooling medium are provided at the both ends of the case in the width direction, thereby cooling the heat transmitted to the case with the cooling medium flowing through the gap without being blocked by the spacers. That is, the cooling effect of the battery modules can be increased even with a small gap without losing the heat releasing effect of the holder. As a result, a battery pack can be provided, which exhibits a great cooling effect of battery modules and requires less space.

A battery pack according to the present invention includes a plurality of battery modules stacked one on another. Each of the battery modules includes a holder accommodating a plurality of cells and made of a thermal conductive material, and a rectangular solid case accommodating the holder. The holder includes a plurality of containers, in each of which one of the cells is accommodated. The case has a first side surface and a second side surface, which are parallel to side surfaces of the containers of the holder, and face each other. The battery pack is formed by stacking the plurality of battery modules in a direction that the first side surface and the second side surface overlap each other. Spacers, each having a predetermined width, are provided between adjacent two of the battery modules at both ends of the first and second side surfaces of the case in a width direction, along a direction perpendicular to the width direction. The spacers form a gap, through which a cooling medium flows, between the first and second side surfaces.

In the battery pack, each of the spacers is preferably provided in a position not overlapping the holder when the first and second side surfaces of the case are viewed in plan. This increases the cooling effect of the battery modules.

The cells are preferably accommodated in the respective containers so that outer peripheral surfaces of the cells contact inner peripheral surfaces of the containers. This improves the heat releasing effect of the holder.

### Advantages of the Invention

The present invention provides a battery pack exhibiting a great cooling effect of battery modules and requiring less space as a battery pack formed by stacking a plurality of battery modules.

### BRIEF DESCRIPTION OF THE DRAWINGS

FIG. 1 is a schematic cross-sectional view illustrating the structure of a cell used in a battery module according to the present invention.

FIG. 2 is a schematic cross-sectional view illustrating the structure of a battery module forming a battery pack according to a first embodiment of the present invention.

FIG. 3A is a perspective view illustrating the structure of a holder accommodating a plurality of cells in a battery module. FIG. 3B is a perspective view of the battery module.

FIG. 4 is an exploded perspective view of the battery pack according to the first embodiment of the present invention.

FIG. 5 is a side view of the battery pack according to the first embodiment of the present invention.

FIG. 6 is a top view of the battery module according to the first embodiment of the present invention.

FIG. 7 is a perspective view of a battery module according to a variation of the first embodiment of the present invention.

FIG. 8 is an exploded perspective view of a battery pack according to the variation of the first embodiment of the present invention.

FIG. 9 is a side view of the battery pack according to the variation of the first embodiment of the present invention.

FIG. 10 is a top view of the battery module according to the variation of the first embodiment of the present invention.

FIG. 11 is a top view of a battery module according to a second embodiment of the present invention.

FIG. 12 is a top view a battery module according to a variation of the second embodiment of the present invention.

FIG. 13 is a perspective view illustrating the form of a spacer according to the second embodiment of the present invention.

FIG. 14 is a side view illustrating the structure of a battery pack according to another embodiment of the present invention.

FIG. 15 is a side view illustrating the structure of a battery pack according to yet another embodiment of the present invention.

### DESCRIPTION OF EMBODIMENTS

Embodiments of the present invention will be described hereinafter with reference to the drawings. Note that the present invention is not limited to the following embodiments. Certain modifications and changes may be made within the scope of the advantages of the present invention. Each embodiment may be combined with the other embodiments.

### First Embodiment

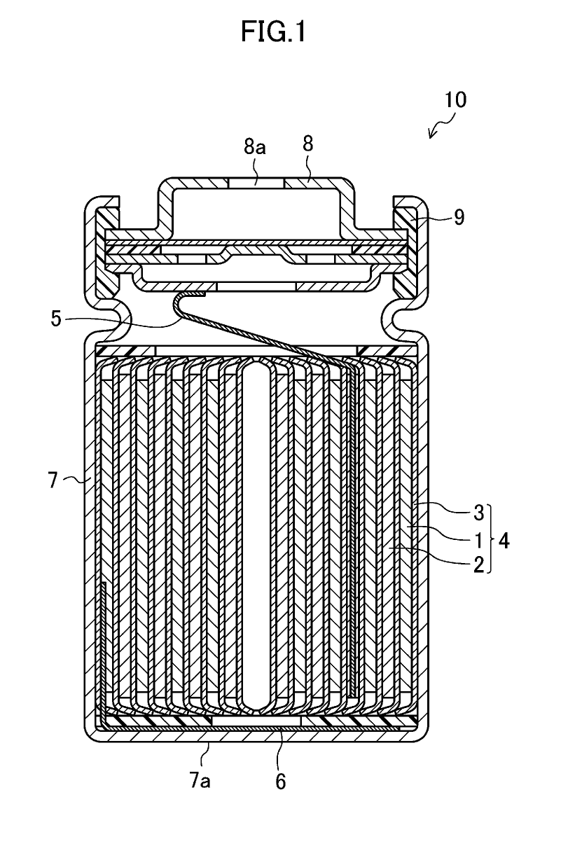

FIG. 1 is a schematic cross-sectional view illustrating the structure of a cell 10 used in a battery module according to a first embodiment of the present invention. The type of the cell 10 according to the present invention is not limited, and for example, a secondary battery such as a lithium-ion battery and a nickel hydride battery may be used. The battery is not limited to a cylindrical battery, and may be a rectangular battery.

As shown in FIG. 1, in the cell 10, an opening of a battery case 7 is sealed with a sealing plate 8 with gaskets 9 interposed therebetween. An electrode group 4, which is formed by winding a positive electrode 1 and a negative electrode 2 with a separator 3 interposed therebetween, is accommodated in the battery case 7 together with a nonaqueous electrolyte. The positive electrode 1 is connected to the sealing plate 8, which also serves as a positive electrode terminal, via a positive electrode lead 5. The negative electrode 2 is connected to the bottom of the battery case 7, which also serves as a negative electrode terminal, via a negative electrode lead 6. Note that the sealing plate 8 includes an opening 8a, through which abnormal gas is discharged outside the battery case 7 from the opening 8a in generation of the abnormal gas in the cell 10.

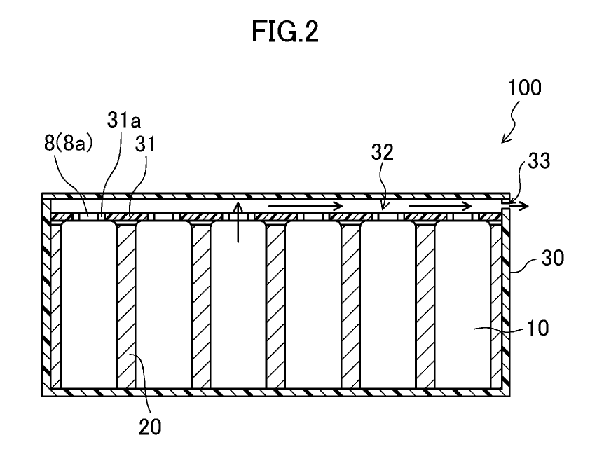

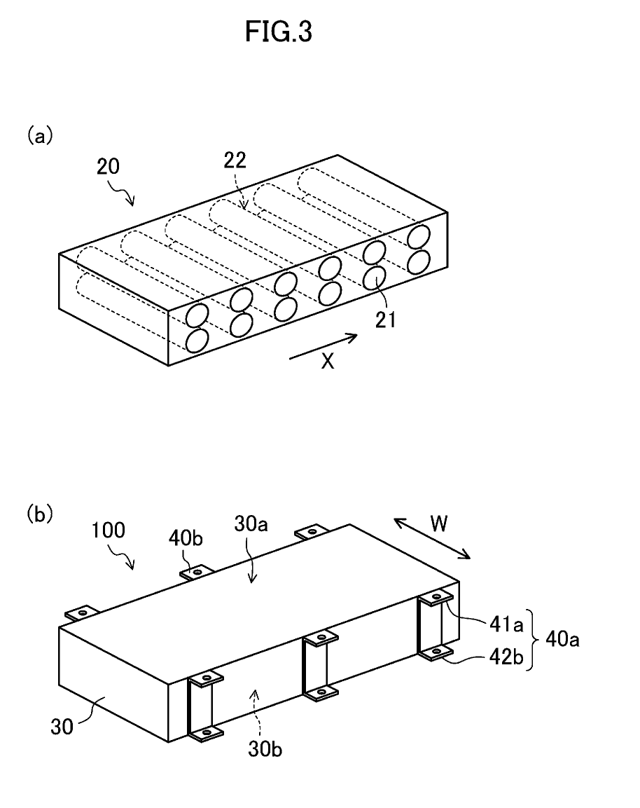

FIG. 2 is a schematic cross-sectional view illustrating the structure of a battery module 100 forming the battery pack according to the first embodiment of the present invention. FIG. 3A is a perspective view illustrating the structure of a holder 20 which accommodates a plurality of cells 10 in the battery module 100. FIG. 3B is a perspective view of the battery module 100.

As shown in FIG. 2, in the battery module 100, the plurality of cells 10 are arranged and accommodated in a case 30. The plurality of cells 10 are accommodated in the holder 20 shown in FIG. 3A. Each of the cells 10 is accommodated in a tubular container 21 formed in the holder 20. The holder 20 is made of a thermal conductive material. The cells 10 are accommodated in the containers 21 so that the outer peripheral surfaces of the cells contact the inner peripheral surfaces of the containers 21. This structure immediately releases the heat generated in the cells 10 to the holder 20, thereby effectively reducing a temperature rise of the cell 10.

The material of the holder 20 is not limited, but aluminum, copper, etc. are preferably used. Alternatively, resin may be used, which is made thermally conductive by adding aluminum oxide, titanium oxide, aluminum nitride, etc.

The holder 20 may be formed by assembling a plurality of tubular pipe holders, which accommodate the respective plurality of batteries 10.

The “tubular” shape is not limited to a cylindrical shape, but may be, for example, a rectangular tubular shape.

Note that the outer peripheral surfaces of the cells 10 may not necessarily contact the inner peripheral surfaces of the containers 21. This is because, if the gaps between the outer peripheral surfaces of the cells 10 and the inner peripheral surfaces of the containers 21 are small, the heat generated in the cells 10 is sufficiently transmitted to the holder 20 by heat radiation. Alternatively, other thermal conductive members may fill the gaps.

A flat plate 31 is provided at the positive electrode terminals 8 of the plurality of cells 10, thereby segmenting an exhaust chamber 32 between the case 30 and the flat plate 31. The flat plate 31 is provided with through-holes 31a, into which the positive electrode terminals 8 of the cells 10 are inserted, and abnormal gas discharged from the openings 8a of the cells 10 are discharged outside the case 30 from an outlet 33 provided in the case 30 via the exhaust chamber 32. The discharge mechanism is not limited to the structure shown in FIG. 2, and the battery module may lack a discharge mechanism.

The case 30 of the battery module 100 is parallel to sides 22 of the containers 21 in the holder 20 as shown in FIG. 3A, and has a first surface 30a and a second surface 30b, which are parallel to the arrangement direction X of the containers 21, i.e., the arrangement direction of the cells 10, and face each other, as shown in FIG. 3B. The case 30 is provided with pairs of joints 40a and 40b at the both ends of the width direction W of the first and second side surfaces 30a and 30b.

While an example has been described where the cells 10 are arranged in two lines in the X direction in FIG. 3A, the “arrangement direction of the cells 10” includes not only the X direction but also the direction perpendicular to the X direction, where, for example, the cells 10 are arranged in a matrix (including a staggered fashion).

The pairs of joints 40a and 40b may be formed integrally with the case 30, or may be attached to the case 30 as separate members.

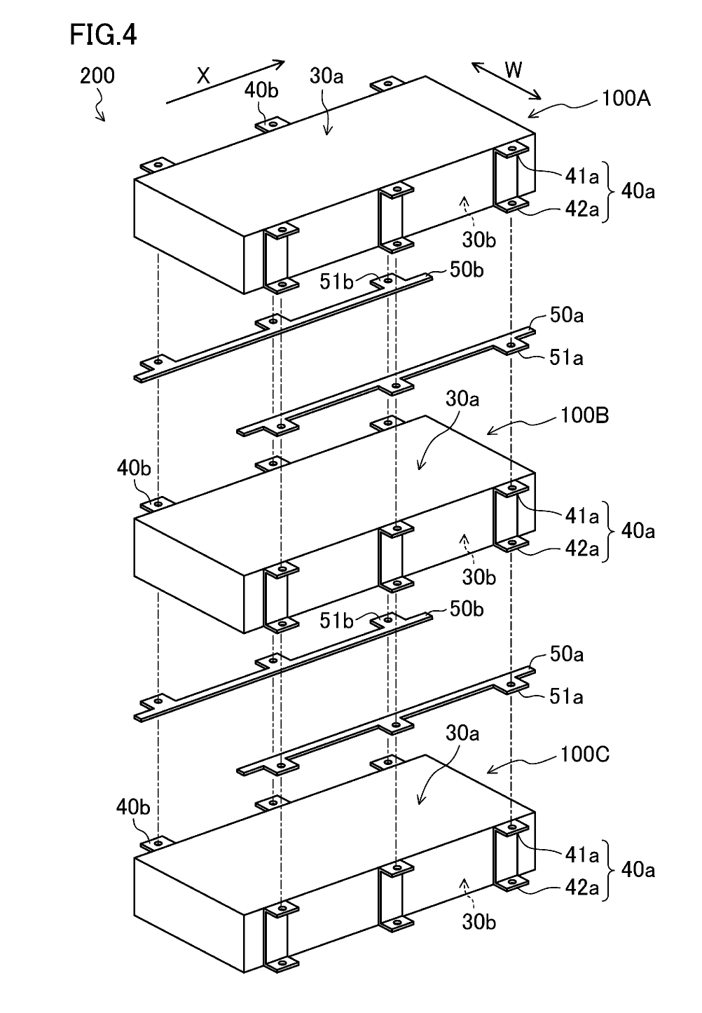

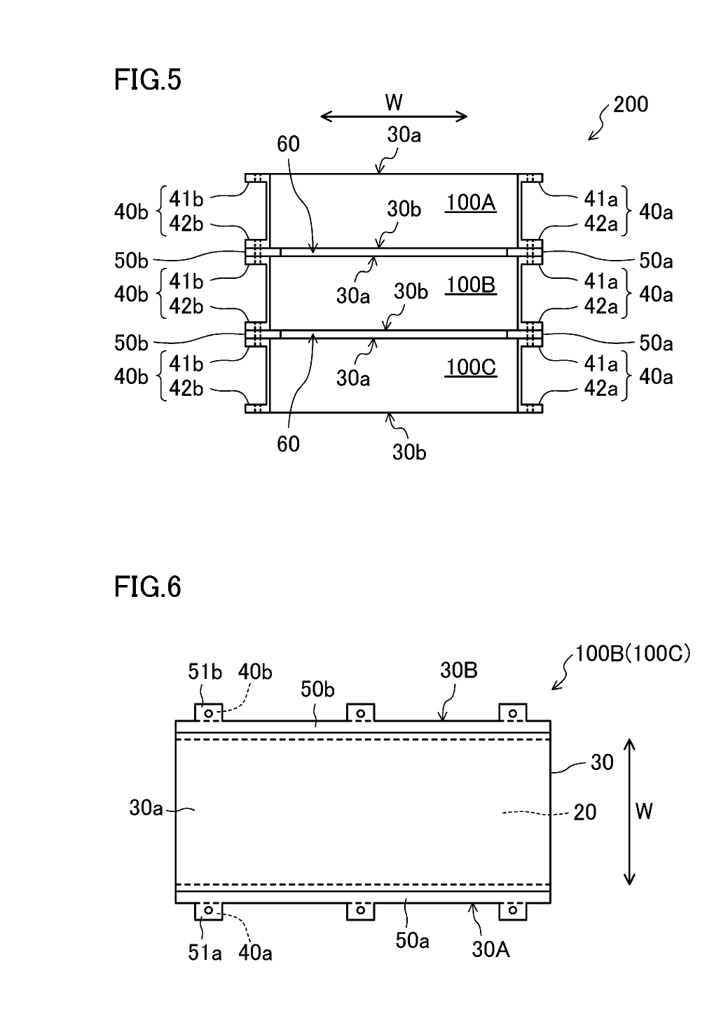

FIG. 4 is an exploded perspective view of the battery pack 200 according to the first embodiment of the present invention. FIG. 5 is a side view of the assembled battery pack 200.

As shown in FIGS. 4 and 5, the battery pack 200 according to this embodiment is formed by stacking a plurality of battery modules 100A, 100B, and 100C in the direction that the first surfaces 30a and the second surfaces 30b overlap each other. The spacers 50a and 50b with a predetermined width are provided between the adjacent battery modules 100A and 100B, and between 100B and 100C at the both ends of the first and second side surfaces 30a and 30b of the cases 30 in the width direction W, along the direction X (hereinafter referred to as a “longitudinal direction X” for simplicity) perpendicular to the width direction W. The spacers 50a and 50b form a gap 60, through which a cooling medium flows, between the first and second side surfaces 30a and 30b.

The spacers 50a and 50b are provided with tabs 51a and 51b at an end in the width direction, respectively. The battery modules 100A, 100B, 100C are connected by pairs of joints 40a and 40b in the stacking direction. The spacers 50a and 50b are fixed to the joints 40a and 40b by the tabs 51a and 51b, respectively. Specifically, bolt holes (or screw holes) may be formed in the joints 40a and 40b and the tabs 51a and 51b to fix the spacers 50a and 50b by bolts (screws).

With this structure, the cells 10 are accommodated in the holder 20 made of a thermal conductive material, thereby immediately releasing the heat generated in the cells 10 into the case 30 of the battery module 100. The spacers 50a and 50b forming the gap 60, which is a flow path of the cooling medium, are provided at the both ends of the case 30 in the width direction W, thereby cooling the heat transmitted to the case 30 with the cooling medium flowing through the gap 60 without being blocked by the spacers 50a and 50b. That is, the cooling effect of the battery module 100 can be increased without loosing the heat releasing effect of the holder 20 even with a small gap 60, thereby providing the battery pack 200 exhibiting a great cooling effect of the battery module 100 and requiring less space.

FIG. 6 is a top view of the battery module 100B (or 100C), which is located at an inner side in the stacking direction, viewed from the first side surface 30a of the case 30.

As shown in FIG. 6, the spacers 50a and 50b are provided at both ends 30A and 30B of the first and second side surfaces 30a and 30b of the case 30 in the width direction W. The spacers 50a and 50b are preferably provided in positions not overlapping the holder 20 when the first side surface 30a of the case 30 is viewed in plan. This further increases the cooling effect of the battery module 100 without loosing the heat releasing effect of the holder 20 by blocking with the spacers 50a and 50b even with a small gap 60. As long as the heat releasing effect of the holder 20 is not reduced, each of the spacers 50a and 50b may have a portion overlapping the holder 20 when the first side surface 30a of the case 30 is viewed in plan.

As shown in FIG. 6, the ends of the spacers 50a and 50b in the width direction W are preferably flush with the ends 30A and 30B of the first and second side surfaces 30a and 30b of the case 30 in the width direction W. As a result, the side surfaces of the battery module 100 in the longitudinal direction are formed flat.

### Variation of First Embodiment

In the first embodiment, the spacers 50 with a predetermined width are provided between the adjacent battery modules 100, thereby forming the gap 60, through which the cooling medium flows, between the first and second side surfaces 30a and 30b of the case 30.

However, the gap 60, through which the cooling medium flows, can be formed between the first and second side surfaces 30a and 30b of the case 30 without providing the spacers 50.

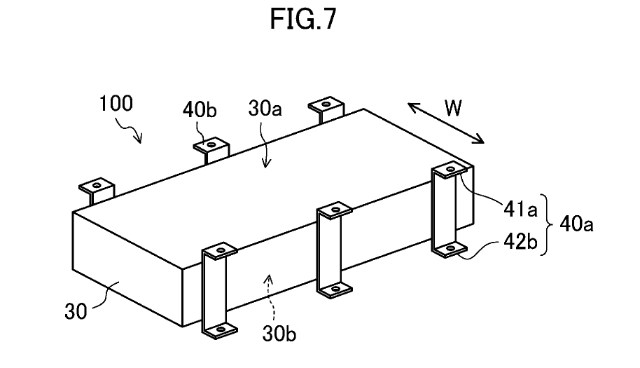

FIG. 7 is a perspective view of a battery module 100 according to a variation of the first embodiment.

As shown in FIG. 7, similar to what is shown in FIG. 3B, in the case 30 of the battery module 100 according to this variation, pairs of joints 40a and 40b are provided at the both ends of the first and second side surfaces 30a and 30b in the width direction W. However, the feature of the pairs of joints 40a and 40b according to this variation is that the height is greater than the height of the case 30 (i.e., the distance between the first and second side surfaces 30a and 30b). That is, the both ends of the pairs of joints 40a and 40b project from the first and second side surfaces 30a and 30b in opposite directions.

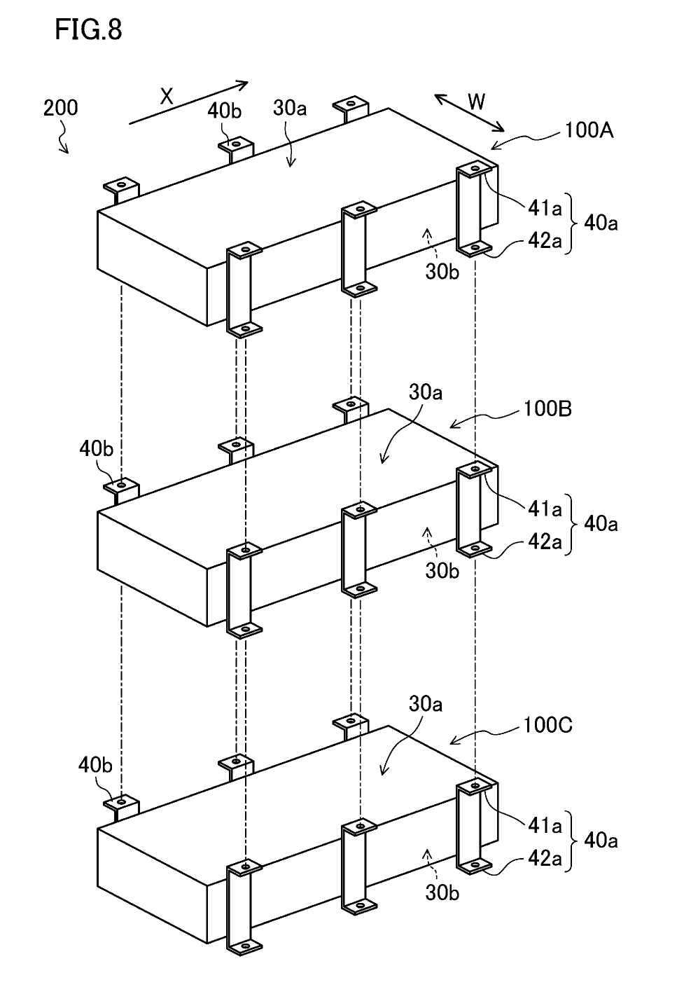

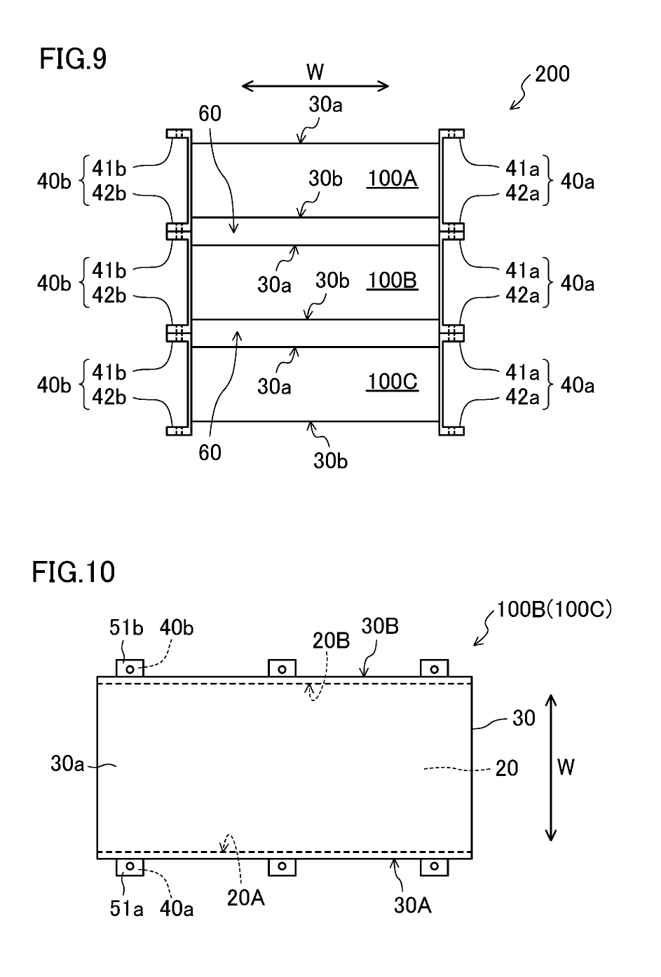

FIG. 8 is an exploded perspective view of the battery pack 200 according to this variation. FIG. 9 is a side view of the assembled battery pack 200.

As shown in FIGS. 8 and 9, the battery pack 200 according to this variation is formed by stacking a plurality of battery modules 100A, 100B, and 100C in the direction that the first and second side surfaces 30a and 30b overlap each other. The adjacent battery modules 100A and 100B, and the 100B and 100C are connected by the pairs of joints 40a and 40b in the stacking direction. Specifically, bolt holes (or screw holes) may be formed in the joints 40a and 40b to fix with bolts (screws).

Since the both ends of the pairs of joints 40a and 40b project from the first and second side surfaces 30a and 30b of the case 30 in opposite directions; the gap 60, through which the cooling medium flows, can be formed between the first and second side surfaces 30a and 30b.

With this structure, the cells 10 are accommodated in the holder 20 made of a thermal conductive material, thereby immediately releasing the heat generated in the cells 10 into the case 30 of the battery module 100; and the battery modules are connected by the pairs of joints 40a and 40b, thereby forming the gap 60 between the first and second side surfaces 30a and 30b of the case 30 to cool the heat transmitted to the case 30 with the cooling medium flowing through the gap 60. As a result, the battery pack 200 can be provided, which exhibits a great cooling effect of battery modules 100 and requires less space.

The height of the gap 60 between the first and second side surfaces 30a and 30b of the case 30 can be controlled by the length of the projection of the both ends of the pairs of joints 40a and 40b from the first and second side surfaces 30a and 30b of the case 30.

FIG. 10 is a top view of the battery module 100B (or 100C) which is located at an inner side in the stacking direction when viewed from the first side surface 30a of the case 30.

In this variation, since no spacer is provided between the first and second side surfaces 30a and 30b of the case 30, the ends 20A and 20B of the holder 20 in the width direction W can be closer to or flush with the ends 30A and 30B of the first and second side surfaces 30a and 30b of the case 30 in the width direction W as shown in FIG. 10.

While in this variation, the pairs of joints 40a and 40b are provided at the both ends of the first and second side surfaces 30a and 30b of the case 30 in the width direction W, the pairs of joints may be integrally formed at the both ends to be continuous in the X direction along the first and second side surfaces 30a and 30b of the case 30.

### Second Embodiment

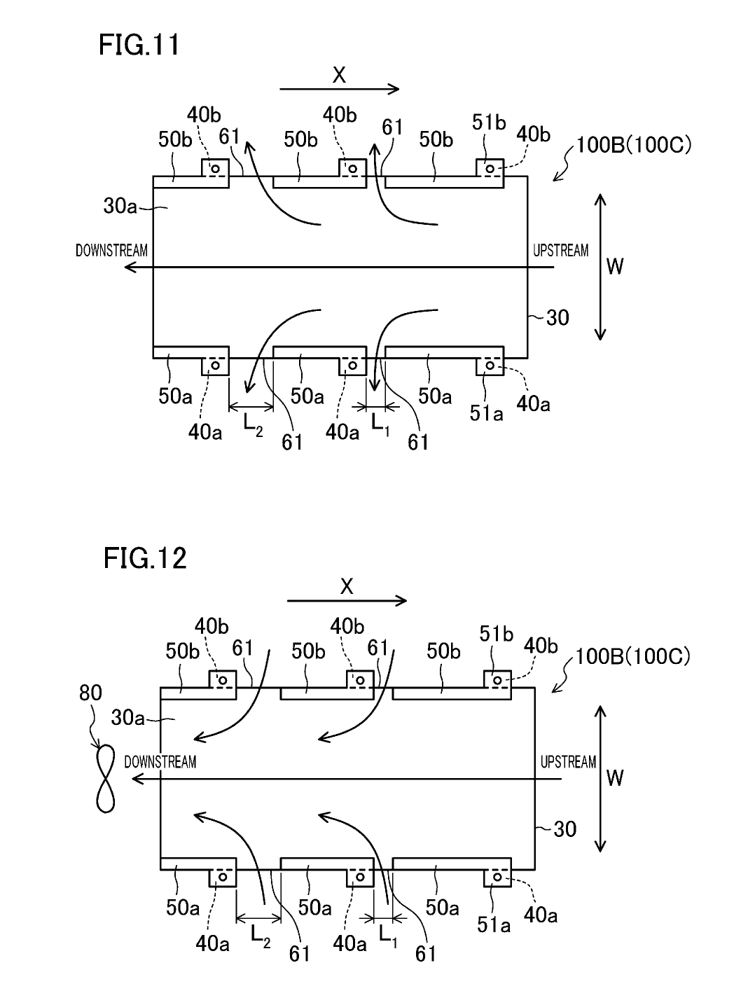

The forms of the spacers 50a and 50b according to a second embodiment of the present invention will be described below with reference to FIGS. 11-15.

FIG. 11 is a top view of the battery module 100B (or 100C) which is located at an inner side in the stacking direction when viewed from the first side surface 30a of the case 30.

As shown in FIG. 11, a plurality of (three in FIG. 11) pairs of joints 40a and 40b are provided at equal intervals along the first side surface 30a of the case 30 in the longitudinal direction X. A plurality (three in FIG. 11) of spacers 50a and 50b are fixed to the respective joints 40a and 40b to be spaced apart from each other, thereby forming openings 61 at the both ends of the first side surface 30a in the width direction W. Part of the cooling medium, which flows from the upstream to the downstream along the longitudinal direction X of the first side surface 30a and is warmed on the way, can be discharged outside from the openings 61 in the width direction of the first side surface 30a as indicated by the arrows. As a result, the unheated cooling medium can flow into the gap 60 and thus, the cooling effect of the battery modules can be further increased.

The cooling medium flowing along the longitudinal direction X of the first side surface 30a is increasingly warmed as it comes closer to the downstream. As shown in FIG. 11, the length of the spacers 50a and 50b, which are fixed to the joints at the downstream, is formed shorter than the length of the spacers 50a and 50b, which are fixed to the joints at the upstream, so that the width L2 of the openings 61 at the downstream is greater than the width L1 of the openings 61 at the upstream, thereby efficiently discharging the warmed cooling medium outside in the width direction of the first side surface 30a.

As shown in FIG. 12, a fan may be provided at the downstream to forcibly move the cooling medium from the upstream to the downstream. This allows the gap 60 to intake the cooling medium from the openings 61 provided along the longitudinal direction X of the first side surface 30a as indicated by the arrows. As a result, the cooling effect of the battery modules can be increased, since a fresh cooling medium can be added to the cooling medium which flows from the upstream to the downstream and is warmed on the way.

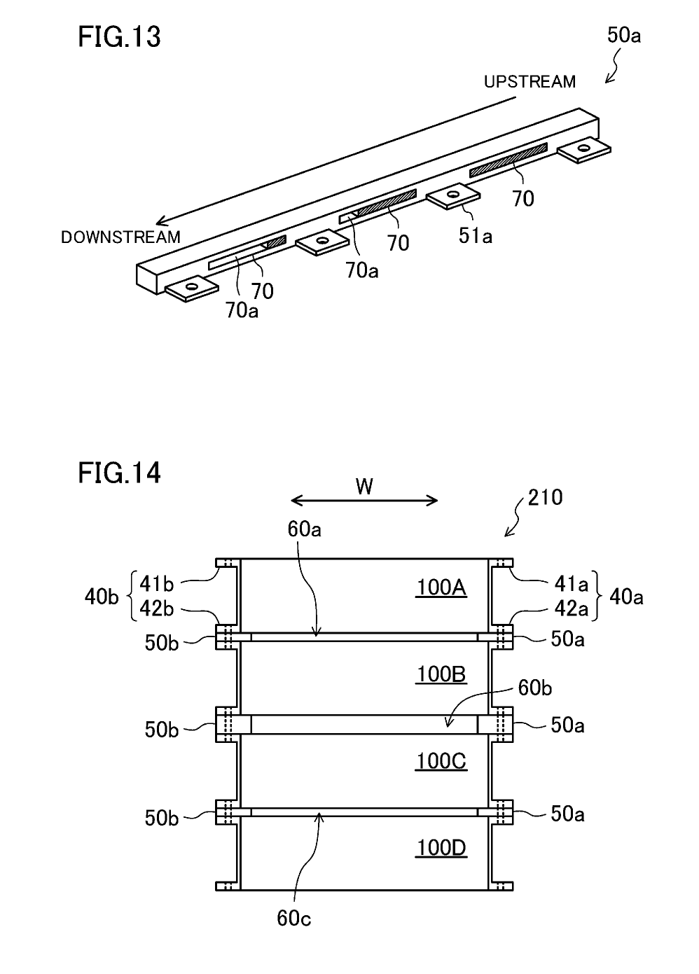

FIG. 13 is a perspective view illustrating another form of the spacer 50a according to this embodiment. As shown in FIG. 13, the spacer 50a includes a plurality of windows 70, which can be opened and closed in the longitudinal direction, on their both side surfaces along the longitudinal direction of the first and second side surfaces 30a and 30b. As a result, openings formed of a single member and corresponding to the openings 61 shown in FIG. 11 are provided in the spacers 50a. For example, as shown in FIG. 13, the length of the one of openings 70a of the windows 70 at the downstream of the cooling medium is formed greater than the length of the one of the openings 70a of the windows 70 at the upstream, thereby efficiently discharging the part of the cooling medium, which flows from the upstream to the downstream and is warmed on the way, outside in the width direction of the first side surface 30a.

### Other Embodiments

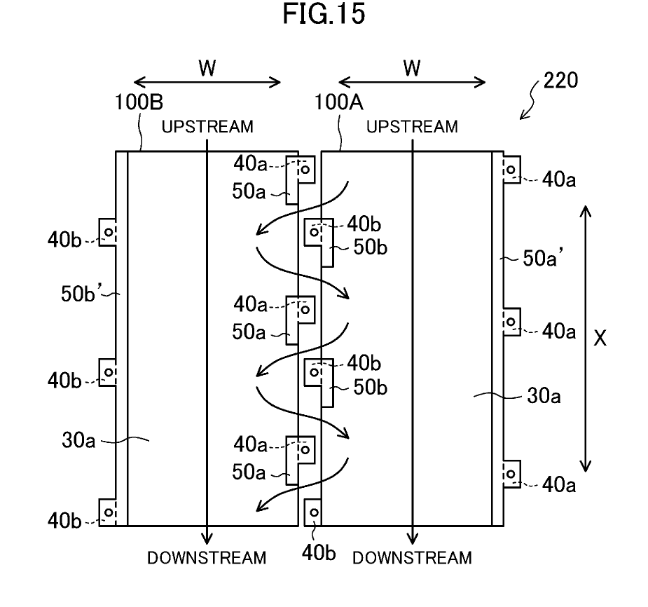

FIG. 14 is a side view illustrating the structure of a battery pack 210 according to another embodiment of the present invention.

As shown in FIG. 14, the battery pack 210 is formed by stacking a plurality of battery modules 100A-100D. In this case, the heat is less released from the battery modules 100B and 100C located at the inner side in the stacking direction, as compared to the battery modules 100A and 100D located at the outer side in the stacking direction. Thus, the height of the spacers 50a and 50b, which are provided between the battery modules 100B and 100C located at the inner side in the stacking direction, is formed greater than the height of the spacers 50a and 50b, which are provided between the battery modules 100A and 100B (or 100C and 100D) located at the outer side in the stacking direction. Accordingly, a gap 60b formed between the battery modules 100B and 100C can be larger than a gap 60a (or 60c) between the battery modules 100A and 100B (or between 100C and 100D), and thus, heat release of the battery modules 100B and 100C located at the inner side in the stacking direction can be improved.

FIG. 15 is a top view illustrating the structure of a battery pack 220 according to yet another embodiment of the present invention.

As shown in FIG. 15, the battery pack 220 is formed by arranging the battery modules 100A and 100B in parallel in the width direction of the first and second side surfaces 30a and 30b of the case 30. A plurality of pairs of joints 40a and 40b are provided in alternately shifted positions at the both ends of the first side surface 30a in the width direction W along the longitudinal direction X of the first side surface 30a. The spacers 50a and 50b are fixed to the respective joints 40a and 40b to be spaced apart from each other. Single continuous spacers 50a′ and 50b′ are provided at the external ends of the first side surface 30a of the case 30 in the width direction W along the longitudinal direction X.

With this structure, as indicated by the arrows in FIG. 15, part of the cooling medium flowing from the upstream to the downstream windingly flows between the battery modules 100A and 100B, which are adjacent to each other in the parallel direction. This uniformly cools the battery modules 100A and 100B which are adjacent to each other in the parallel direction.

As described above, while the present invention has been described in connection with preferred embodiments, but it is not intended to limit the scope to the description, and of course, various modifications may be made. For example, while in the above-described embodiments, the cooling medium flows along the longitudinal direction X of the first and second side surfaces 30a and 30b of the case 30, it may flow along the width direction W of the first and second side surfaces 30a and 30b. The shape of the case 30 is not limited to a mathematically exact rectangular solid, and may be, for example, a rounded shape or a cube. While the stacked battery modules are connected by the joints, the method is not limited thereto and may be connected by other methods (e.g., binding with binding bands). While the spacers are fixed to the joints with the tubs, the method is not limited thereto and may be fixed by other methods (e.g., bonding, etc.).

### INDUSTRIAL APPLICABILITY

The present invention is useful for driving power sources of vehicles, electric motorcycles, electric play equipments, etc.

### DESCRIPTION OF REFERENCE CHARACTERS

1 Positive Electrode
2 Negative Electrode
3 Separator
4 Electrode Group
5 Positive Electrode Lead
6 Negative Electrode Lead
7 Battery Case
8 Positive Electrode Terminal (Sealing Plate)
8a Opening
9 Gasket
10 Cell
20 Holder
21 Container
30 Case
30a First Side Surface
30b Second Side Surface
31 Flat Plate
31a Through-Hole
32 Exhaust Chamber
33 Outlet
40a, 40b Joints
50a, 50b Spacers
51a, 51b Tubs
60 Gap
61 Opening
70 Window
100 Battery Module
200, 210, 220 Battery Packs

1. A battery pack comprising a plurality of battery modules stacked one on another, wherein
each of the battery modules includes
a holder accommodating a plurality of cells and made of a thermal conductive material, and
a rectangular solid case accommodating the holder,
the holder includes a plurality of containers, in each of which one of the cells is accommodated,
the case has a first side surface and a second side surface, which are parallel to side surfaces of the containers of the holder, and face each other,
the battery pack is formed by stacking the plurality of battery modules in a direction that the first side surface and the second side surface overlap each other,
spacers, each having a predetermined width, are provided between adjacent two of the battery modules at both ends of the first and second side surfaces of the case in a width direction, along a direction perpendicular to the width direction, and
the spacers form a gap, through which a cooling medium flows, between the first and second side surfaces.

2. The battery pack of claim 1, wherein
each of the spacers is provided in a position not overlapping the holder when the first and second side surfaces of the case are viewed in plan.

3. The battery pack of claim 1, wherein
the cells are accommodated in the respective containers so that outer peripheral surfaces of the cells contact inner peripheral surfaces of the containers.

4. The battery pack of claim 1, wherein
ends of the spacers in the width direction are flush with the ends of the first and second side surfaces of the case in the width direction.

5. The battery pack of claim 1, wherein
the case includes a pair of joints at the both ends of the first and second side surfaces in the width direction,
each of the spacers includes tabs at ends of the spacer in the width direction,
the plurality of battery modules are connected by the pair of joints in a stacking direction, and
the spacers are fixed to the joints by the tubs.

6. The battery pack of claim 5, wherein
multiple ones of the pair of joints are provided at equal intervals along a longitudinal direction of the first and second side surfaces of the case, and
the spacers are fixed to the respective joints to be spaced apart from each other.

7. The battery pack of claim 6, wherein
the cooling medium flows through the gap in a direction perpendicular to the width direction of the first and second side surfaces, and
the spacer fixed to one of the joints, which is located at a downstream of the cooling medium, has a shorter length than the spacer fixed to one of the joints, which is located at an upstream.

8. The battery pack of claim 1, wherein
each of the spacers includes a plurality of windows at both side surfaces of the spacer along the direction perpendicular to the width direction of the first and second side surfaces, the windows being openable and closable in the direction.

9. The battery pack of claim 8, wherein
the cooling medium flows through the gap in the direction perpendicular to the width direction of the first and second side surfaces, and
an open portion of one of the windows, which is located at a downstream of the cooling medium, has a greater length than an open portion of one of the windows, which is located at an upstream.

10. The battery pack of claim 1, wherein
the spacer, which is provided between ones of the battery modules located at an inner side in a stacking direction, has a greater height than the spacer, which is provided between ones of the battery modules located at an outer side in the stacking direction.

11. The battery pack of claim 1, wherein
the holder is made of aluminum, copper, or resin, to which aluminum oxide, titanium oxide, or aluminum nitride is added.

12. The battery pack of claim 1, wherein
the holder is formed by assembling a plurality of tubular pipe holders, each accommodating one of the plurality of cells.

13. The battery pack of claim 5, wherein
the plurality of battery modules are provided in parallel in the width direction of the first and second side surfaces of the case,
multiple pairs of joints are provided in alternately shifted positions at both ends of the first and second side surfaces in the width direction along the direction perpendicular to the width direction of the first and second side surfaces, and
the spacers are fixed to the respective joints to be spaced apart from each other.

14. A battery pack comprising a plurality of battery modules stacked one on another, wherein
each of the battery modules includes
a holder accommodating a plurality of cells and made of a thermal conductive material, and
a rectangular solid case accommodating the holder,
the holder includes a plurality of containers, in each of which one of the cells is accommodated,
the case has a first side surface and a second side surface, which are parallel to side surfaces of the containers of the holder, and face each other,
a pair of joints, which project from the first and second side surfaces in a stacking direction and has a greater height than the case, are provided at the both ends of the first and second side surfaces in the width direction,
the plurality of battery modules are connected by the pair of joints in the stacking direction, and
a gap, through which a cooling medium flows, is formed between the first and second side surfaces.
